(19) United States
(12) Patent Application Publication
(10) Pub. No.: US 2009/0100024 A1
(43) Pub. Date: Apr. 16, 2009

(54) MULTI-MODAL MOBILE PLATFORM

(76) Inventors: Nasser K. Manesh, Mountain View, CA (US); Saied Kazemi, Irvine, CA (US)

Correspondence Address: STETINA BRUNDA GARRED & BRUCKER, 75 ENTERPRISE, SUITE 250, ALISO VIEJO, CA, 92656, US

(21) Appl. No.: 12/249,762

(22) Filed: Oct. 10, 2008

Related U.S. Application Data
(60) Provisional application No. 60/979,194, filed on Oct. 11, 2007.

(51) Int. Cl. G06F 7/06; G06F 17/30

(52) U.S. Cl. 707/3; 707/E17.108

(57) ABSTRACT

There is provided a multi-modal mobile platform system for permitting a user to interact and exchange data through a mobile device. It will be appreciated that the present invention may be employed on any mobile device such as a cellular phone or Personal Digital Assistant (PDA) and the like. It is contemplated that the multi-modal platform (MMP) provides the basic constructs for a unified multi-modal data access and query platform that will overcome the deficiencies of the services based on a uni-modal platform such as web-only services or text messaging only services. The present system may use a Voice Portal, a Text Messages Portal, an eMail Portal, a Web Portal, a Downloadable Application Portal, or a WAP or Mobile Web Portal to facilitate communication between a user and third parties.

### CROSS-REFERENCE TO RELATED APPLICATIONS

This application claims the benefit of U.S. Provisional Application No. 60/979,194, filed on Oct. 11, 2007, the teachings of which are expressly incorporated by reference.

### STATEMENT RE: FEDERALLY SPONSORED RESEARCH/DEVELOPMENT

Not Applicable

### BACKGROUND

1. Field of the Invention

This invention relates generally to the field of data communication on mobile devices and more particularly, to multi-modal platform data querying for mobile devices using various portals for communication and accessing data.

2. Related Art

Information networks, such as the Internet, have blossomed from a medium for simple data exchange and messaging to the fastest growing, most innovative medium for information exchange and commerce. Virtual shopping malls, buying services, and other types of sophisticated information exchanges are being employed by an ever increasing number of retail merchants, commercial enterprises, and consumers alike. With this reallocation of commerce and business being conducted over the Internet, retailers and service providers expend vast resources to provide visually appealing and technologically efficient communication exchanges for users to access data.

With the rapid rise in popularity of Internet commerce and information services, and the rapid evolution of computer and communications technologies, great strides have been made in improving the timeliness, quality, quantity, and, perhaps most importantly, the types of communication platforms for exchanging data or communicating. Whereas in the past, the data was primarily exchanged through file transfer and with the exchange of text-based messages, today data networks are routinely used for distributing elaborate, interactive, real-time graphical displays, real-time audio, and real-time video. These technological improvements greatly increase user appeal to adapt to such communication methods and resultantly generate increased traffic and greater revenues. The mobile device industry has embraced data communication from the advent of the Personal Digital Assistant (PDA) to the ever dependent reliance placed on the cellular phone.

Prior art content providers often utilize an uni-modal approach for data communication on mobile devices. Specifically, if a user were to query the content provider by using one communication method, the content provider would return the query results via the same communication method. One such example is with Google Text. Google Text permits users to submit a query for a business address via sending an SMS text message. Subsequently, Google will return the results using the same communication method or a return SMS text message.

However, such static and rigid communication rules are not always user friendly or the most an efficient means to foster communication. This is particularly true as various industries begin to adopt business models or strategies to incorporate mobile devices. For example, SMS text messages may be useful to submit a query for a business address, but it may not be the ideal communication method for the return query results especially if the results may include a large amount of data that would require multiple SMS text messages or even if the user cares to access the data when her attention should be focused, such as while driving a car. Alternatively, a user may submit a query via a text message desiring to access the query results upon a different computing device such as a personal computer.

Accordingly, there is currently a need in the art for an improved system for facilitating data communication.

### BRIEF SUMMARY

In accordance with the present invention, there is provided a multi-modal mobile platform system for permitting a user to interact and exchange data through a mobile device. It will be appreciated that the present invention may be employed on any mobile device such as a cellular phone or Personal Digital Assistant (PDA) and the like. It is contemplated that the multi-modal platform (MMP) provides the basic constructs for a unified multi-modal data access and query platform that will overcome the deficiencies of the services based on a uni-modal platform such as web-only services or text messaging only services.

A basic embodiment of the present system may include a three tiered architecture having a User Access Portal Layer, an Application Layer, and a Database and Data Access Layer. The User Access Portal Layer may provide multiple portals to facilitate user communication. In this regard, a portal allows a user to communicate with or submit a query to a content provider or a data source. In a preferred embodiment of the present invention, the MMP may include six portals for user communication: Voice Portal, SMS Portal, Mobile Web Portal, eMail Portal, Online Web Portal, and Downloadable Application Portal. However, it is contemplated that any communication modality that transmits data may be employed with various aspects of the present system.

The Application Layer is where the business logic may be programmed and implemented and consequently generates query results for the system. The Database and Data Access Layer is the internal data, customer information, customization information, advertising messages and business data may be deposited and stored. It is contemplated that any communications modality such as the Internet, wireless technology, proprietary network and the like may be employed to foster communication between the various layers of the present system.

The MMP advantageously provides a unified experience for the user for each respective portal. In other words, regardless of the portal used to query the data, the same results may be returned with appropriation for the capability of the portal. Therefore, while the presentation of the data is changed to suit the portal used, the core information is retained to ensure the user receives the desired data. In addition, the interaction history for the user is unified and consolidated, and may further be available for user inspection in one normalized format regardless of the portal used to make the query. For example, people searching for information via voice or text message may find their search history easily on the web using their personal computer (PC).

Another object of the present invention is to provide a platform that allows users to cross technologies and thereby use the best available mode of access for initial query and the subsequent response. For example, a user that queries the data using voice through the Voice Portal, and can request to receive the data response in text message format through the Text Message Portal so the user can use the persistence of the SMS text data in their mobile device as oppose to the volatility of the voice response on their phone. For example, a user who queries a Real Estate data source through the voice portal, can chose to receive the price and other characteristics of the property as a text message through SMS text which will give the data more persistence on user's mobile phone.

Another feature of the MMP is to provide advertisers with an efficient and target vehicle for providing content laden messages such as commercial, informational, educational messages to users in a variety of formats. The messages may be directed to users depending on the mode of access or user preference. A text message user may receive text message advertising or informational message whereas a voice portal user may receive the same informational message in voice format. At the same time, the user may specify their preference in format for receiving messages, either during current or a previous interaction with the platform, or on the web portal when they log onto the web site associated with the platform. For example, even though the user is using a phone call and therefore the voice portal, the advertisement can be sent as a text message. Similar examples may be made for other portals. It is contemplated that content providers may also determine which portal data may be exchanged with users.

It is further contemplated that the MMP may provide a platform for advertisers to direct advertisements to interested audiences by allowing advertisers to input data such as user demographics, user customization, and the user query itself as input criteria for finding an appropriate advertisement for a particular user. For example, a user that may use the Voice Portal to search for the prices of digital cameras may be presented with search results and related advertisements. Specifically, the user may be presented with a voice message that provides promotional information about digital camera batteries, which consequently is a relevant and targeted message in the same format that user has opted to use. It is contemplated that any data may be used by advertisers to target users.

The MMP may also provide advertisers with cross-platform correlated data. Particularly, the MMP may provide a relevant advertisement to the user when user opts to use a different portal than the one used for the initial query. In the digital camera example provided above, should the user employ the mobile web portal to look up the history of queries, the user may be presented with a relevant promotional message about the Digital Camera memory on the mobile web portal even though the initial query resulting in this search record was done using the Voice portal. It will be appreciated that such cross correlation of portal interactions and common backend functions are amongst the most power features of the MMP.

Another object of the present invention is to provide relevant advertising messages to the user based on advertisements that the user has previously received from other portals. Specifically, the advertisement history from various portals may be made available as input criteria to the advertising subsystem to choose the best targeted ad in the current interaction and current portal. As an example, a brand advertiser such as Nikon may decide that if the user hears a Nikon ad on the Voice Portal when they are searching for a digital camera, the advertiser may want the user to see a Nikon ad on the Web Portal the next time the user visits the web site in order to increase relevant impressions on the user through association and audio/visual memory. It is contemplated that any portal may be associated with such targeted advertising.

It will be appreciated that the MMP is not a search engine and does not perform complex search operations. In contrast, it provides an application level gateway for various pieces of data that are provided by other software packages such as a search engine or a comparison shopping site, a calendar service, a blog service, or the like. Additionally, it is advantageous that the MMP provides access to the same data via various mobile portals.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a block diagram illustrating multi-modal mobile plateform and various communication portals interacting with online product and sales data, and with online mobile sales and commerce in accordance with various aspects of the present invention; and

FIG. 2 is a block diagram illustrating the overall architecture of the MMP including the relationships between the User Access Portal Layer, Application Layer, and Database and Data Access Layer.

Common reference numerals are used throughout the drawings and the detailed description to indicate the same elements

### DETAILED DESCRIPTION

The detailed description set forth below is intended as a description of the presently preferred embodiment of the invention, and is not intended to represent the only form in which the present invention may be constructed or utilized. The description sets forth the functions and sequences of steps for constructing and operating the invention. It is to be understood, however, that the same or equivalent functions and sequences may be accomplished by different embodiments and that they are also intended to be encompassed within the scope of the invention.

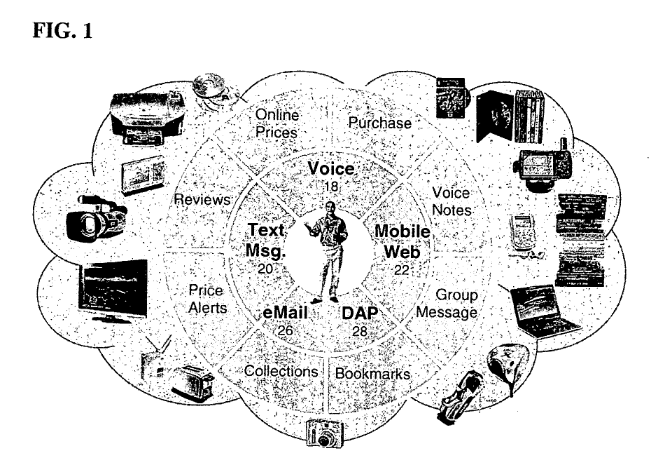

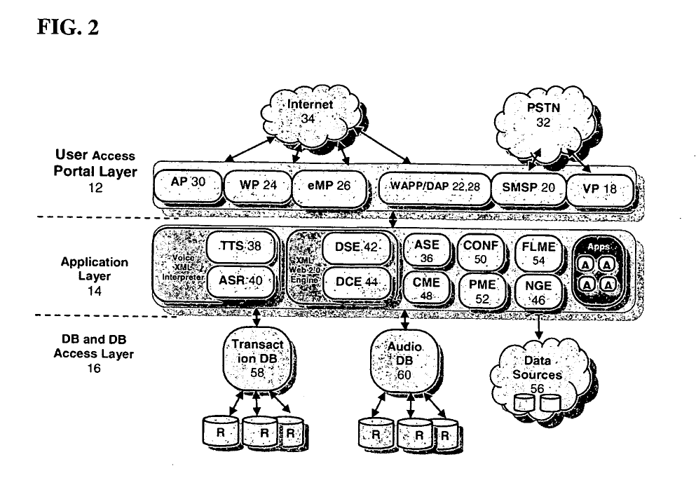

In accordance with one aspect of the present invention, there is provided a Multi-modal Mobile Platform system (MMP) to provide multi-modal access for data communication. FIGS. 1 and 2 illustrate the MMP 10 in accordance with various aspects of the present invention. In the present embodiment, the MMP 10 has a three-tiered architecture including a User Access Portal Layer 12, an Application Layer 14, and a Database and Data Access Layer 16. However, it is contemplated that the MMP 10 may be designed having a single tiered architecture or multi-tiered architecture and that the functional scope of the present system may be incorporated throughout each layer individually or collectively.

The User Access Portal Layer 12 provides users with multi-modal access to the MMP and consists of at least one portal for facilitating data communication. A portal is a data exchange modality that allows a user to communicate with a data source or a content provider and the like. In the present embodiment, the User Access Portal Layer comprises six portals including a Voice Portal 18, SMS Portal 20, WAP or Mobile Web Portal 22, Web Portal 24, an eMail Portal 26, Downloadable Application Portal 28, and an Advertisers Portal 30. However, a person having ordinary skill in the art will understand that the present system may employ any number of data communication portals.

The Voice Portal (VP) 18 is used to communicate with the user through conventional voice technology. In this regard, the user dials a telephone number from standard PSTN 32 (Public Switched Telephone Network) or a mobile telephone network and connects to the portal. The portal subsequently identifies the user using an authentication modality such as the ANI (Automatic Number Identification) of the user's telephone and proceeds to provide the authorized services to the user by connecting the user to the appropriate application from the Application Layer 14. The applications served to the users from Application Layer 14 are voice enabled applications and may use VXML (Voice XML) for implementation of their logic. However, it is contemplated that any programming language may be employed to provide the requisite logic for this application.

The SMS Portal (SMSP) 20 is used to communicate with the user through SMS protocol or Text Messaging. The user sends a query addressed to the data as a text message to a pre-assigned short code SMS number. The SMSP 20 receives the text message and then authenticates the user by verifying the user's identity. It is contemplated that any authentication technique may be employed to verify the user's identity, including using the incoming telephone number of the text message. Subsequently, the SMSP 20 proceeds to provide the authorized services to the user by connecting the user to the appropriate application from the Application Layer 14. The SMSP 20 then re-appropriates the result and returns it to user in the form of a text message.

The WAP or Mobile Web Portal (WAPP) 22 is used to communicate with the MMP 10 through a mobile device that is capable of accessing the Internet 34 using a browser. It is contemplated that the user points their mobile device browser to the MMP's URL (Universal Resource Locator). It is contemplated that the mobile device may access the URL through any telecommunications connectivity modality such as, but not limited to, WAP (Wireless Application Protocol), GPRS (General Packet Radio Service), EDGE (Enhanced Data for GSM), 3G (3^{rd} Generation Data), 4G (4^{th} Generation Data), WiFi, or WiMAX or the like. It is further contemplated that the WAPP 22 may provide output results or query results in a programming language such as WML (Wireless Markup Language), XHTML, HTM/JavaScript/Flash, and the like depending on the compatibility of the mobile device's browser. The mobile device's browser may be determined based on the UA (User Agent) information obtained from the browser. The WAPP 22 subsequently asks the user to login and upon authentication connects the user to the appropriate application from the Application Layer 14. The portal then re-appropriates the result and returns it to user in the form appropriate for the small screen WAP or Mobile Web enabled devices.

The Web Portal (WP) 24 is the online web portal for users to access data sources available to the MMP through the Database and Data Access Layer 16. The WP 24 may also be used to search through records of existing interactions with the MMP 10 which could have been produced through the use of any of the portals. In addition the WP 24 allows the user to configure and customize the behavior of the applications in the Application Layer 14 and further customize the portals in the User Access Portal Layer 12. This configuration and customization includes, but is not limited to, adapting the look and feel of the application through each portal and the nature of the data filters applied to the data at the Application Layer 14. However, it is contemplated that the system may be customized based upon any data parameter relative to user experience and human computer interaction.

The eMail Portal (eMP) 26 is primarily used to provide query access to MMP data through eMail messages. It is contemplated that the MMP 10 is compatible with proprietary email servers such as Microsoft Exchange and the like and also compatible with any conventional email servers such as Yahoo Mail or Microsoft Hotmail and the like. The user's identity is recognized and authenticated through the originating email address and the query result is organized in the form of a return email to the user. However, it is contemplated that the eMP 26 may organize the query result in email form and subsequently transmit the email to any email address determined by the user or content provider.

The Downloadable Application Portal (DAP) 28 is used to communicate with the MMP through an application that is downloaded to and resides on the mobile device, and is capable of accessing any communications network such as the Internet 36. The mobile device may access the Internet 34 to communicate with the DAP 28 through various modes of connectivity such as, but not limited to, WAP, GPRS, EDGE, 3G, 4G, WiFi, or WiMAX and the like. The communication between the downloaded application and the DAP 28 may occur over standard protocols such as HTTP (Hyper Text Transfer Protocol) or a proprietary protocol that both DAP 28 and the downloaded application are compatible with. The downloaded application provides functions similar to WAPP 22, but since the downloaded application runs on the mobile device it may use the local operating system of the mobile device to render local user interface elements for the user, and thereby make interactions easier, faster, and more efficient. It is contemplated that third party providers may develop downloadable applications.

In another embodiment of the present invention the present system includes an Advertiser Portal (AP) 30. The AP 30 is a specialized web based online portal that is dedicated to a group of users known as Advertisers. The Advertiser group may access the AP 30 through utilities built into the AP 30 and deposit various messages having a variety of content such as commercial, informational, educational and the like. These messages are then used by the Advertisement Selection Engine (ASE) module 36 to provide timely and related messages to user based on the nature of their interaction while they are using one of the VP 18, SMSP 20, WAPP 22, WP 24, eMP 26, or DAP 28 portals. The ASE 36 is implemented and stored on the Application Layer 14. When needed, the messages are converted to an appropriate form for each portal, Voice for VP 18, Text Message for SMSP 20, WAP or Mobile Web message for WAPP 22, email message for the eMP 26, online message for WP 24, and application message for DAP 28. Therefore, the AP 30 and ASE 36 collectively work to direct appropriate advertisements to users.

The Application Layer 14 is the core of the MMP 10. In this regard, the Application Layer 14 is where the business logic is programmed and implemented to generate the query results for the system. The Application Layer 14 includes a plurality of all purpose services, engines, or programs that are utilized by other layers of the MMP 10. In the present embodiment, the Application Layer 14 comprises a Text to Speech Engine 38, an Automatic Speech Recognition Engine 40, a Data Search Engine 42, a Data Comparison Engine 44, an Advertisement Selection Engine 36, a Network Gateway Engine 46, a Collection Management Engine 48, a User Customization and Configuration Engine 50, a Purchase Management Engine 52, and Friend's List Management Engine 54. However, it is contemplated that the Application Layer 14 may store and run any programmable computer instruction such as a program, service, or engine to manipulate, store, or interact with data.

The Text to Speech Engine (TTS) 38 converts the written text to human speech. The TTS 38 is used primarily by to interact with the user through the VP 18. For example, a user initiated written query may trigger a result from the data source that is converted to spoken words through TTS 38. The result is subsequently communicated back to the user through VP 18. The TTS 38 may also be used by the ASE engine 36 to convert written messages to spoken messages for use with the VP 18.

Automatic Speech Recognition Engine (ASR) 40 performs a reverse function of TTS 38. In this regard, the ASR 40 is used to convert spoken query words to text. The ASR 40 is primarily used in recognizing the spoken words coming through the VP 18 and converting it to text so other applications in the Application Layer 14 can process the query.

The Data Search Engine 42 performs the search on the online data based on the user query or other application initiated queries. Data Comparison Engine 44 performs various forms of comparison amongst data components based on user or other application generated queries.

Advertisement Selection Engine (ASE) 36 selects the most appropriate advertisement message from a pool of messages, based on a variety of criteria. In the present embodiment, the ASE 36 selects the appropriate message based on relevance of the message to the user query by matching the message-supplied key words against the user query criteria, Date and Time of the query, Type of input portal (VP 18, SMSP 20, WAPP 22, WP 24, eMP 26, DAP 28), User supplied customization and configuration parameters, or User demographics. However, it is contemplated that the ASE 36 may use any user criteria based on any data parameter to select messages for a particular user.

The Network Gateway Engine (NGE) 46 provides the necessary authentication, translations, filtering, and caching to efficiently communicate with an external data source 56. The external data source 56 may be any data source such as an internet based data source or the like. In the present embodiment, the NGE 46 supports XML data format to efficiently communicate with external data sources. However, it is contemplated that the NGE may support any data format to effectively communicate with external data sources.

The Collection Management Engine (CME) 48 manages user interactions or queries. Specifically, all user queries are kept in a user accessible ‘user history log’. These interactions may be placed in variety of collections. It is contemplated that collections are organized with conventional data structures such as matrices, arrays, lists, and the like. Collections are applied to any number of “items of interest” to the user, such as collections of products, collections of events, collections of blog posts or RSS feeds, or the like. It is contemplated that the CME 48 may comprise any number of collections. In the present embodiment, the CME 48 includes the History Collection and the Bookmarks Collection. The History Collection stores the history of all the user's transactions. The Bookmarks Collection collects the history of the transactions the user would like to highlight as ‘bookmarked’.

The user manages items in these collections or moves them into other customized or predetermined collections through the Web Portal 24. For example, in the case of products, the user moves or copies products from the History Collection or the Bookmarks Collection into a custom list such as a “Wishlist”, “Favorite Gadgets List”, “Books Read List”, “Movies I Own List”, or the like. It is contemplated that the user may employ any list or customized collection to organize data. Collections and lists advantageously permit the user to organize and manage data. Collections are user managed through accessing the CME 48 from any of the VP 18, SMSP 20, WAPP 22, eMP 26, WP 24, or DAP 28 portals. However, it is preferred that collections are managed through WAPP 22, WP 24, or DAP 28 for efficiency. Additionally, the CME 48 allows the user to attach specific functions to any transaction log. For example, a user may wish to attach a personalized Voice Note to a transaction log, or attach an alert to a transaction log when the condition of that log item changes in the source data. An example would be attaching an alert function to a searched product and requesting an alert message when the price of the product falls below a threshold. However, it is contemplated that an alert may be associated with any data parameter associated with the present system.

The User Customization and Configuration Engine (CONF) 50 customizes the look and feel of the data presented to the user through any of the portal as well as changing the applications behavior by managing them through the CONF engine 50. Thus, the CONF 50 allows the user to personalize the present system to provide greater comfort and increase efficiency. The Purchase Management Engine (PME) 52 coordinates the purchase function between the MMP 10 and sales transactions with merchants. The Friends List Management Engine (FLME) 54 supports group messaging using the eMail, Voice, Text Message, or Downloadable Application. It is contemplated that a user on this platform can define one or more Friends (or Buddy) lists. At times the user can decide to send to such list or lists a message (written or spoken) or to send one or more items from the users history. The FMLE module 54 is responsible for that interaction as well managing the user's friends list. The Friends Lists can be stored either locally, or can be retrieved remotely from a third-party social networking site such as Facebook or the like that makes the friends map of a user available through certain APIs (Application Programming Interfaces).

The MMP 10 abstracts the above mentioned engines or services into a set of XML objects with which other applications can interact. However it is contemplated that any programmable data structure may be used to organize the data. Other “application connectors” in the Application Layer 14 can be specifically designed to perform a business function, interface with an external third party application, make queries, and pass the data to the base services to be presented to the user via various portals. As an example, consider an online calendar service such as Google Calendar or the like which publish data in a certain format. A user can create an application connector for Google Calendar that retrieves the published data and pass it to the Voice or Text Message engines so that the user can access the same calendar data by placing a phone call or sending an SMS. Conventionally, a user would typically use the Internet 34 from a PC to look at his or her calendar, but the present system provides a robust means to access data in a convenient technological methods.

It is contemplated that the various online data tools such as web blog entries using an RSS feed, web journaling, and the like may be employed by the system. Such application connectors use various utility engines described above to implement their logic. Users can use the Web Portal 24 to configure, personalize, and enable/disable the connectors for their preferred applications. Developers can use the published programmable scripts using XML objects, APIs, and the like to create more application connectors.

The Database and Data Access Layer 16 is where the internal data, customer information, customization information, Advertising messages and business data is deposited. However it is contemplated that any data or metadata referenced by the user or third party content providers may be stored on the data layer. It is contemplated that certain data components of the business data may be stored externally and may be accessed through the NGE. The internal data is managed through Transaction Database Manager (TDM) 58, which is responsible for recording user interactions, preferences and logs, and the Audio Database Manager (ADM) 60 which responsible for managing the audio files created by users or advertisers. There is a single Read/Write copy of these databases with multiple Read-only copies for redundancy and efficiency of access. However the Database and Data Access Layer 16 may employ any database structure or data organizational tool having various Read/Write attributes.

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

What is claimed is:

1. A unified multi-modal query and data access system for permitting a user to interact with the data, the system comprising:
a user access portal layer comprising at least one mobile communication portal configured to allow the user to send a query to the application layer and to access data resulting from the query and an online web portal configured to allow the user to access data from the data access layer, wherein the user may interact with the data via any of the portals;
an application layer configured to process the user's query and to provide data dependent on the query to the user; and
a data access layer configured to retain the user's information, past queries, and data interactions.

2. The system of claim 1 wherein the mobile communication portals are accessed by a mobile device.

3. The system of claim 2 wherein the mobile device is a conventional cellular phone.

4. The system of claim 1 wherein the mobile communication portal is a voice portal.

5. The system of claim 4 wherein the user access portal layer comprises a voice portal, a second mobile communication portal and an online web portal.

6. The system of claim 5 wherein the second mobile communication portal is a text message portal.

7. The system of claim 4 wherein the user access portal layer comprises a voice portal, a second mobile communication portal, a third mobile communication portal, and an online web portal.

8. The system of claim 7 wherein the second mobile communication portal and the third mobile communication portal are selected from the group consisting of a text message portal, a mobile web portal, and an email portal.

9. The system of claim 4 wherein the user access portal layer comprises a voice portal, a second mobile communication portal, a third mobile communication portal, a fourth mobile communication portal, and an online web portal.

10. The system of claim 9 wherein the second mobile communication portal, the third mobile communication portal, and the fourth mobile communication portal are selected from the group consisting of a text message portal, a mobile web portal, and an email portal.

11. The system of claim 1 wherein the user access portal layer comprises at least two mobile communication portals and an online web portal.

12. The system of claim 11 wherein the query is sent by one mobile communication portal and the data resulting from the query is accessed by the same mobile communication portal.

13. The system of claim 11 wherein the query is sent by one mobile communication portal and the data resulting from the query is accessed by a different mobile communication portal.

14. The system of claim 13 wherein the query is sent by a voice portal and the data resulting from the query is accessed by a text messaging portal.

15. The system of claim 1 wherein the application layer further comprises an advertisement selection engine configured to present an advertisement to the user, wherein the choice of advertisement presented to the user is dependent on the user's query.

16. The system of claim 15 wherein the advertisement selection engine presents the advertisement to the user through the same communication portal that the user is using to access the data resulting from the query.

17. The system of claim 15 wherein the advertisement selection engine presents the advertisement to the user through a communication portal pre-selected by the user.

18. The system of claim 15 wherein the advertisement selection engine is further configured to access the data access layer and wherein the choice of advertisement presented to the user is further dependent on the user's information.

19. The system of claim 15 wherein the advertisement selection engine is further configured to access the data access layer and wherein the choice of advertisement presented to the user is further dependent on the user's past queries made on any of the portal.

20. The system of claim 19 wherein the a data access layer is further configured to retain advertisements previously presented to the user and wherein the choice of advertisement presented to the user is further dependent on advertisements previously presented to the user via any portal.
